(19) United States
(12) Patent Application Publication
(10) Pub. No.: US 2021/0182799 A1
(43) Pub. Date: Jun. 17, 2021

(54) METHOD AND SYSTEM FOR IDENTIFYING AT LEAST A PAIR OF ENTITIES FOR A MEETING

(71) Applicant: Zensar Technologies Limited, Pune (IN)

(72) Inventors: Sandeep KISHORE, Fremont, CA (US); Sumant KULKARNI, Pune (IN); Agepati JAHNAVI, Pune (IN); Hari Eswar S M, Pune (IN); Aishwarya CHAURASIA, Pune (IN); Richa SAWHNEY, Pune (IN); Shree Krishna SOMANI, Pune (IN)

(21) Appl. No.: 17/116,732

(22) Filed: Dec. 9, 2020

(30) Foreign Application Priority Data
Dec. 13, 2019 (IN) 201921051734

(51) Int. Cl. G06Q 10/10; G06N 5/02; G06N 7/00

(52) U.S. Cl. CPC G06Q 10/1095; H04L 67/10; G06N 7/005; G06N 5/02

(57) ABSTRACT

Disclosed herein is a system and method for identifying entities from a service provider side and a client side for a meeting. The system identifies a client service having a highest similarity score with the service type required by the client. It then identifies, a first set of service provider and client entities. It further identifies a second set of service provider and client entities based on a plurality of service provider and client parameters respectively such that the second set of service provider and client entities have a highest similarity score vis-à-vis the first set of service provider and client entities respectively. Further, it generates, based on a set of predicted time dependent win-ratios, one or more combinations comprising at least a pair of entities. Each combination is assigned with a success score and at least one combination is selected based on the success score.

### TECHNICAL FIELD

The present invention relates to data analysis, and more particularly to analyzing data of an organization to provide an optimize match of entities for attending a meeting.

### BACKGROUND OF THE INVENTION

In this competitive world, it becomes utmost important to make best use of the available resources to successfully attend any business opportunity with a client. The first step towards successfully attending the business opportunity is to find a suitable contact, within an organization, who can take the discussion ahead by establishing a successful meeting with the contacts associated with the client as randomly selecting a contact from the organization without considering the needs, likes and dislikes of the client may not yield positive results. It is, therefore, important to understand the needs of the client and thereafter, select best possible contacts from the organization based on—the client needs and the ability of the contacts to successfully attend a meeting.

The challenge is how to identify those contacts internal and external to the organization who would be most suitable for successfully attending the business meetings. Organization stores and manages huge amount data related to client details, employee details, past deals, and the like in a form of structured and unstructured format. However the technical problem is how to analyze such huge data to arrive at some meaningful insight. Specially, in the huge organizations like MNCs, corporates where lot of people leaves and joins the organization, analyzing such huge amount of data flow becomes another challenge.

The information disclosed in this background of the disclosure section is only for enhancement of understanding of the general background of the invention and should not be taken as an acknowledgement or any form of suggestion that this information forms the prior art already known to a person skilled in the art.

### SUMMARY OF THE INVENTION

The present disclosure overcomes one or more shortcomings of the prior art and provides additional advantages discussed throughout the present disclosure. Additional features and advantages are realized through the techniques of the present disclosure. Other embodiments and aspects of the disclosure are described in detail herein and are considered a part of the claimed disclosure.

In one embodiment of the present disclosure, a method for identifying at least a pair of entities for a meeting is disclosed. The method comprises receiving a meeting information between a client and a service provider. The method further comprises determining, based on the meeting information, a service type to be provided to the client by the service provider. The method further comprises identifying a client service, from a plurality of client services provided over a period of time by the service provider and stored in a deal database, having a highest similarity score with the service type to be provided to the client. The method further comprises identifying, from the deal database, a first set of service provider entities and a first set of client entities based on the client service identified to be similar to the service type. The first set of service provider entities and the first set of client entities were involved in executing the client service between the service provider and the client respectively. The method further comprises identifying a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively. The method further comprises predicting a set of time dependent win-ratios, corresponding to the second set of service provider entities in such a manner that each time dependent win-ratio indicates a capability of a service provider entity of the second set of service provider entities to successfully execute the meeting with the client. Further, the method comprises generating, based on the set of time dependent win-ratios, one or more combinations comprising at least a pair of entities taken from the second set of service provider entities and the second set of client entities. Each combination is assigned with a success score predicting a probability for successfully attending the meeting, and at least one combination is selected based on the success score.

In one embodiment of the present disclosure, a system for identifying at least a pair of entities for a meeting is disclosed. The system comprises a receiving unit configured to receive a meeting information between a client and a service provider. The system further comprises a determination unit configured to determine, based on the meeting information, a service type to be provided to the client by the service provider. The system further comprises a client service identification unit configured to identify a client service, from a plurality of client services provided over a period of time by the service provider and stored in a deal database, having a highest similarity score with the service type to be provided to the client. The system further comprises an entity identification unit is configured to identify, from the deal database, a first set of service provider entities and a first set of client entities based on the client service identified to be similar to the service type. The first set of service provider entities and the first set of client entities were involved in executing the client service between the service provider and the client respectively. The entity identification unit is further configured to identify a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively. The system further comprises a prediction unit configured to predict a set of time dependent win-ratios, corresponding to the second set of service provider entities in such a manner that each time dependent win-ratio indicates a capability of a service provider entity of the second set of service provider entities to successfully execute the meeting with the client. Further, the system comprises a generation unit configured to generate, based on the set of time dependent win-ratios, one or more combinations comprising at least a pair of entities taken from the second set of service provider entities and the second set of client entities. Each combination is assigned with a success score predicting a probability for successfully attending the meeting, and at least one combination is selected based on the success score.

In one embodiment of the present invention, a non-transitory computer-readable storage medium is disclosed. The medium stored instructions that when processed by a processor cause the system to perform operations. The operations comprise receiving a meeting information between a client and a service provider. The operations further comprise determining, based on the meeting information, a service type to be provided to the client by the service provider. The operations further comprise identifying a client service, from a plurality of client services provided over a period of time by the service provider and stored in a deal database, having a highest similarity score with the service type to be provided to the client. The operations further comprise identifying, from the deal database, a first set of service provider entities and a first set of client entities based on the client service identified to be similar to the service type, such that the first set of service provider entities and the first set of client entities were involved in executing the client service between the service provider and the client respectively. The operations further comprise identifying a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively. The operations further comprise predicting a set of time dependent win-ratios, corresponding to the second set of service provider entities in such a manner that each time dependent win-ratio indicates a capability of a service provider entity of the second set of service provider entities to successfully execute the meeting with the client. The operations further comprise generating, based on the set of time dependent win-ratios, one or more combinations comprising at least a pair of entities taken from the second set of service provider entities and the second set of client entities, where each combination is assigned with a success score predicting a probability for successfully attending the meeting, and at least one combination is selected based on the success score.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The embodiments of the disclosure itself, as well as a preferred mode of use, further objectives and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 shows an exemplary environment 100 of a system for identifying at least a pair of entities for a meeting, in accordance with an embodiment of the present disclosure;

FIG. 2 shows a block diagram 200 illustrating a system for identifying at least a pair of entities for a meeting, in accordance with an embodiment of the present disclosure;

FIG. 3 shows a method 300 for identifying at least a pair of entities for a meeting, in accordance with an embodiment of the present disclosure; and

FIG. 4 shows a block diagram of an exemplary computer system 400 for implementing the embodiments consistent with the present disclosure.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

The foregoing has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure.

The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Disclosed herein is a system and method for identifying entities associated with a service provider and a client for a meeting between the service provider and the client. In the highly competitive world of today, it is very important for business organizations/service providers to make the best possible use of the available resources in order to score maximum business opportunities and in turn maximize their profits. Business organizations/service providers often engage in meetings with clients to either pitch their product, or offer solutions to clients based on their needs, etc. However, it may so happen that the entities (or people or connects or person) from the business organization/the service provider that were engaged in a meeting with a client do not understand the likes, dislikes and the needs of the client and were therefore, not able to successfully execute the meeting. This could therefore incur huge losses to the business organization/the service provider and would also hamper the professional growth of the entities engaged in the meeting. It may, however, be understood that an entity from the business organization/the service provider may not be capable of handling different clients. He/she may have been very successful with a certain client but not so much with some other client. For instance, a certain entity under the sales division of the business organization/the service provider might have been successful in handling national clients but not so successfully in handling international clients, or an entity from the legal division of the business organization/the service provider would not have appropriate skills to make a sales pitch to a client. It is, therefore, very crucial to select the best possible entities from the business organization/the service provider based on the needs, likes and dislikes of the client and the ability of various entities within the organization to successfully execute a meeting with a client.

The present disclosure understands this need and provides a system that first understands the kind of service required by a client by matching it with the services provided by the business organization/the service provider in the past and based on the understanding determines entities from the business organization/the service provider that are best suited to execute the meeting with the client. The system also determines entities from the client side that should be contacted for the meeting such that when the chosen entities from the business organization/the service provider side engage in a meeting with the chosen entities from the client, the likelihood of the meeting being successful is very high. For such identification, the system disclosed in the present disclosure analyses data from different perspectives, for example, service provider's perspective, client's perspective, past deal's perspective to find an optimal combination of people from service provider side as well as client side to attend the meeting, which has been explained in upcoming paragraphs of the specification.

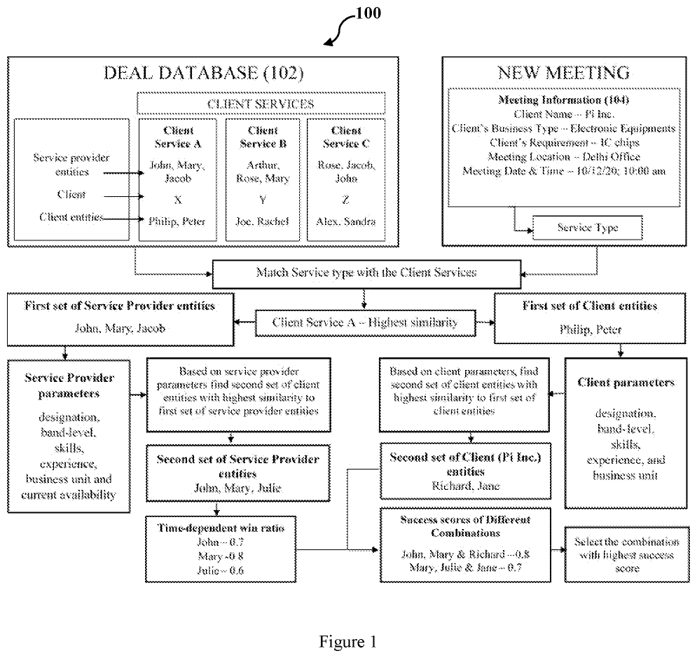

FIG. 1 shows an exemplary environment 100 of a system for identifying at least a pair of entities for a meeting, in accordance with an embodiment of the present disclosure. It must be understood to a person skilled in art that the system may also be implemented in various environments, other than as shown in FIG. 1.

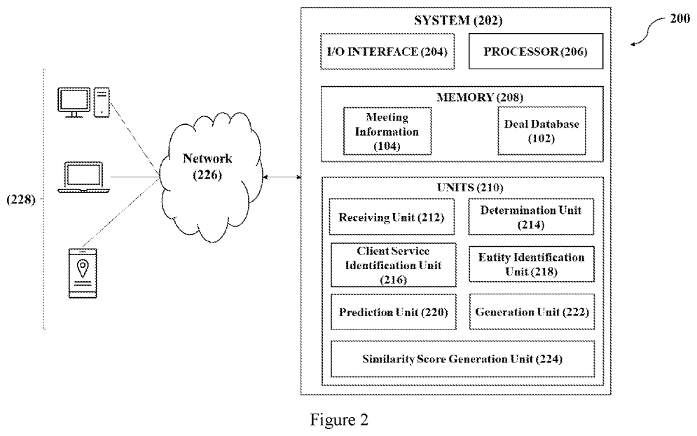

The detailed explanation of the exemplary environment 100 is explained in conjunction with FIG. 2 that shows a block diagram 200 of a system for identifying at least a pair of entities for a meeting, in accordance with an embodiment of the present disclosure. Although the present disclosure is explained considering that the system 202 is implemented on a server, it may be understood that the system 202 may be implemented in a variety of computing systems, such as a laptop computer, a desktop computer, a notebook, a workstation, a mainframe computer, a server, a network server, a cloud-based computing environment. It may be understood that the system 202 may be accessed by multiple users through one or more user devices 228 or applications residing on the user devices. In one implementation, the system 202 may comprise the cloud-based computing environment in which a user may operate individual computing systems configured to execute remotely located applications. Examples of the user devices 228 may include, but are not limited to, a IoT device, IoT gateway, portable computer, a personal digital assistant, a handheld device, and a workstation. The user devices 228 are communicatively coupled to the system 202 through a network 226.

In one implementation, the network 226 may be a wireless network, a wired network or a combination thereof. The network 226 can be implemented as one of the different types of networks, such as intranet, local area network (LAN), wide area network (WAN), the internet, and the like. The network 226 may either be a dedicated network or a shared network. The shared network represents an association of the different types of networks that use a variety of protocols, for example, Hypertext Transfer Protocol (HTTP), Hypertext Transfer Protocol Secure (HTTPS), Transmission Control Protocol/Internet Protocol (TCP/IP), Wireless Application Protocol (WAP), and the like, to communicate with one another. Further the network 226 may include a variety of network devices, including routers, bridges, servers, computing devices, storage devices, and the like.

In one implementation, the system 202 may comprise an I/O interface 204, a processor 206, a memory 208 and the units 210. The memory 208 may be communicatively coupled to the processor 206 and the units 210. Further, the memory 208 may store a deal database 102 and meeting information 104. The significance and use of each of the stored quantities is explained in the upcoming paragraphs of the specification. The processor 206 may be implemented as one or more microprocessors, microcomputers, microcontrollers, digital signal processors, central processing units, state machines, logic circuitries, and/or any devices that manipulate signals based on operational instructions. Among other capabilities, the processor 206 is configured to fetch and execute computer-readable instructions stored in the memory 208. The I/O interface 204 may include a variety of software and hardware interfaces, for example, a web interface, a graphical user interface, and the like. The I/O interface 204 may allow the system 202 to interact with the user directly or through the user devices 228. Further, the I/O interface 204 may enable the system 202 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting many devices to one another or to another server.

In one implementation, the units 210 may comprise a receiving unit 212, a determination unit 214, a client service identification unit 216, an entity identification unit 218, a prediction unit 220, a generation unit 222 and a similarity score generation unit 224. According to embodiments of present disclosure, these units 212-224 may comprise hardware components like processor, microprocessor, microcontrollers, application-specific integrated circuit for performing various operations of the system 202. It must be understood to a person skilled in art that the processor 206 may perform all the functions of the units 212-224 according to various embodiments of the present disclosure.

Now, referring to FIG. 1, the environment 100 shows meeting information 104 pertaining to a new meeting with a client received by the system 202 via the receiving unit 212 through a user device 228 connected to the system 202 when a new meeting is scheduled between a service provider and a client. The meeting information 104 comprises details such as client name (e.g., Pi Inc.), client's business type (e.g., Electronic Equipments), client's requirement (e.g., IC chips), meeting location (e.g., Delhi office) and meeting date and time (e.g., Dec. 10, 2020; 10:00 AM). The meeting information 104 is stored in the memory 208. Based on the meeting information 104, the determination unit 214 determines the service type required by the client (Pi Inc.) in the exemplary environment 100. According to the exemplary environment 100, the service type may be determined as requirement of IC Chips by the electronic equipment manufacturing company, Pi. Inc.

Once, the service type required by the client has been determined based on the meeting information 104, the client service identification unit 216 identifies a client service provided by the service provider in the past that best matches the service type. For this, client service identification unit 216 may access the deal database 102 in which data pertaining to past client services is stored. As shown in FIG. 1, the deal database 102 comprises details regarding service provider entities, client name and client entities corresponding to client services A, B and C. Apart from the data shown in FIG. 1, the deal database 102 may store additional data (numeric or text) associated with each client service. Examples of such additional data is presented in table 1.

TABLE 1
Additional data associated with the client services.

| Numeric Data | Text Data |
|---|---|
| Number of people bidding for the | Region |
| service type | |
| Pricing | Competitors - Service Provider |
| | and Client |
| Competitor wallet share | Past relationship with service |
| | provider |
| Customer growth trajectory | Customer relations |
| Billing rates of Different region | Sales regions |

Further, apart from the above listed data, revenue, net income and client assets as extracted from the annual reports of a client by using a Named Entity Recognition (NER) technique may also be stored in the deal database 102. The numeric data stored in the deal database is used as it is, however, the text data is converted into a numeric (machine-readable) form by employing Label Encoding technique. Further, to match the service type with each of the client services A, B and C stored in the deal database 102, cosine similarity technique may be employed. For applying the cosine similarity technique, each of the client services A, B and C stored in the deal database 102, and the determined service type is converted into a vector representation by the similarity score generation unit 224. The similarity score generation unit 224 generates client service vector representations, \vec{A}, \vec{B} and \vec{C} corresponding to client services A, B and C. It further generates a service type vector representation (say \vec{S}) corresponding to the determined service type. The similarity score generation unit 224 then applies the cosine similarity technique on each of the client service vector representation \vec{A}, \vec{B} and \vec{C} vis-à-vis the service type vector representation \vec{S}) to generate a plurality of similarity scores.

For instance, to determine the similarity score between the client service vector representation A and service type vector representation \vec{S}, cosine similarity is applied as—

$$Similarity ( A , S ) = \frac{A \cdot S}{‖ A ‖ \times ‖ S ‖} = \frac{{\sum }_{i = 1}^{n} {A}_{i} \times {S}_{i}}{\sqrt{{\sum }_{i = 1}^{n} {A}_{i}^{2}} \times \sqrt{{\sum }_{i = 1}^{n} {S}_{i}^{2}}}$$

Similar implementation of cosine similarity technique may be applied to determine the similarity score between the client service vector representation \vec{B} and service type vector representation \vec{S} and between the client service vector representation \vec{C} and service type vector representation \vec{S}. The similarity scores generated by this technique are usually in the form of decimals between 0 and 1, where ‘1’ denotes the highest match and ‘0’ denotes the lowest match. However, the similarity score can be converted in other forms such as a percentage based on the type of application.

Now, in the exemplary environment 100 as shown in FIG. 1, the client service A is assumed to have highest similarity with the service type. From the identified client service A, a first set of service provider entities and a first set of client entities are identified by the entity identification unit 218 as the entities that were involved in providing the client service A to a client X. For instance, John, Mary and Jacob are identified as the “first set of service provider entities” whereas Philip and Peter are identified as the “first set of client entities”.

Further, for the identified first set of service provider entities, the entity identification unit 218 identifies a plurality of service provider parameters. These parameters may comprise, but not limited to, at least one of designation, band-level, skills, experience, business unit and current availability. Similarly, for the identified first set of client entities, the entity identification unit 218 identifies a plurality of client parameters. These parameters may comprise, but not limited to, at least one of designation, band-level, skills, experience and business unit. This step is crucial for the system 202 to understand what kind of entities would be suitable for executing the meeting with the client Pi. Inc. in terms of the kind of skills required by the entities, the required experience, the business unit association of the entities etc. Further, it also helps in indicating the kind of entities that would be suitable to be approached from the client side for the meeting. For instance, in the exemplary environment 100, the first set of service provider entities are identified as John, Mary and Jacob. For each of the identified service provider entities, the above-mentioned parameters are considered as shown as an example in table 2.

TABLE 2
Service provider parameters

| Parameters | John | Mary | Jacob |
|---|---|---|---|
| Designation | Marketing | Sales Manager | Manager- |
| | Manager | | Manufacturing |
| | | | Division |
| Band-level | Mid-level | Mid-level | Senior-level |
| Skills | Strong | Systematic | Strong project |
| | communication, | execution of | management |
| | networking | sales plan, strong | skills, timely |
| | and planning | communication, | order |
| | skills | details to pricing | completion |
| Experience | 3 years | 4 years | 6 years |
| Current | Available | Available | Unavailable |
| Availability | | | |

Based on the above-mentioned service provider parameters, the entity identification unit 218 understands that for executing the meeting for the determined service type, the service provider entities must include a Sales Manager, a Marketing Manager and a Manager from the Manufacturing Division. Now, the entity identification unit 218 identifies a “second set of service provider entities” that have a high similarity score against the “first set of service provider entities”—John, Mary and Jacob. For this, again cosine similarity technique is employed. For applying the cosine similarity technique, each of the first set of service provider entities—John, Mary and Jacob are converted into a first set of service provider vector representations by the similarity score generation unit 224. Further, a remaining set of entities associated with the service provider, excluding the first set of service provider entities, are also converted into a second set of service provider vector representation. The similarity score generation unit 224 then applies the cosine similarity technique on each of the first set of service provider vector representations corresponding to John, Jacob and Mary vis-à-vis the second set of service provider vector representations corresponding to the remaining set of service provider entities.

Based on the similarity scores and the current availability status, a second set of service provider entities is identified. For instance, as shown in table 2, the current availability status of John and Mary is listed as “available” while that of Jacob is listed as “Unavailable”. Therefore, since John and Mary are available, the second set of service provider entities include John and Mary. However, since Jacob is not available due to any of the reasons, Julie is identified as a third member of the second set of service provider entities having highest similarity score in comparison to Jacob. Therefore, the second set of service provider entities now include John, Mary and Julie. In one embodiment, the second set of service entities can be same as the first set of service provider entities if each of the first set of service provider entities are listed as available. In another embodiment, the second set of service provider entities may be entirely different or a subset of the first set of service provider entities depending on the current availability status of each of the first set of service provider entities.

Further, similar processing is done by the similarity score generation unit 224 to identify a second set of client entities corresponding to the client (Pi Inc.) having a highest similarity to the first set of client entities corresponding to client X associated with client service A. This is achieved first generating a first set of client vector representations corresponding to the first set of client entities and generating a second set of client vector representations corresponding to a plurality of client entities corresponding to the client Pi Inc. Further, the cosine similarity technique is applied on the second set of client vector representations vis-à-vis the first set of client vector representations respectively to calculate a plurality of similarity scores in order to identify the second set of client entities. In the exemplary environment 100 as shown in FIG. 1, Richard and Jane are identified as the second set of client entities corresponding to the client Pi Inc. and having highest similarity scores in comparison to the first set of client entities—Philip and Peter corresponding to client X. Further, in the exemplary environment 100, the client Pi Inc. is a new client and therefore, the second set of client entities can neither be same as the first set of client entities and nor be the subset of the first set of client entities. However, in another embodiment if the client Pi Inc. is not a new client, then the second set of client entities may either be same as the first set of client entities or a subset of the first set of client entities.

Once, the second set of service provider entities have been identified by the entity identification unit 218, the prediction unit 220 predicts win-ratio for each of the second set of service provider entities for the current time frame by employing an Auto-Regressive Integrated Moving Average (ARIMA) model. The win-ratio helps in predicting the capability of an entity for successfully executing a meeting. The prediction of the win-ratio for the current time frame is based on the calculated win-ratios for the previous time frames. The time frame can be monthly, quarterly, half-yearly or yearly. Further, in one embodiment the win-ratio may be calculated as the weighted average of the number of meetings divided by number of wins for each of the second set of service provider entities. It may be understood by a skilled person that there may be other methods of calculating the win-ratio than the one described herein. As shown in the exemplary environment 100, the win-ratios of the second set of service provider entities—John, Mary and Julie for the current time frame are predicted to be 0.7, 0.8 and 0.6 respectively. This implies that Mary has the highest probability of successfully executing a meeting in comparison to John and Julie.

Further, the generation unit 224 generates one or more combinations of the second set of service provider entities and the second set of client entities. Each combination is simultaneously assigned a success score based on the predicted win-ratios of each of the second set of service provider entities. The assigned success score predicts a probability of successfully attending the meeting when executed by the entities present in the one or more combinations. For instance, as shown in the exemplary environment 100, the generation unit 224 generates two combinations. The first combination comprises John and Mary from the second set of service provider entities and Richard from the second set of client entities. This combination is assigned a success score of 0.8. Whereas, the second combination comprises Mary and Julie from the second set of service provider entities and Jane from the second set of client entities. This combination is assigned a success score of 0.7. The first combination has a higher success score in comparison to the second combination as the cumulative win-ratio of service provider entities (John and Mary) of the first combination is greater than the cumulative win-ratio of service provider entities (Mary and Julie) of the second combination. Based on the determined success scores of each of the one or more combinations, the service provider can appropriately select the combination that would have the highest probability for successfully attending the meeting.

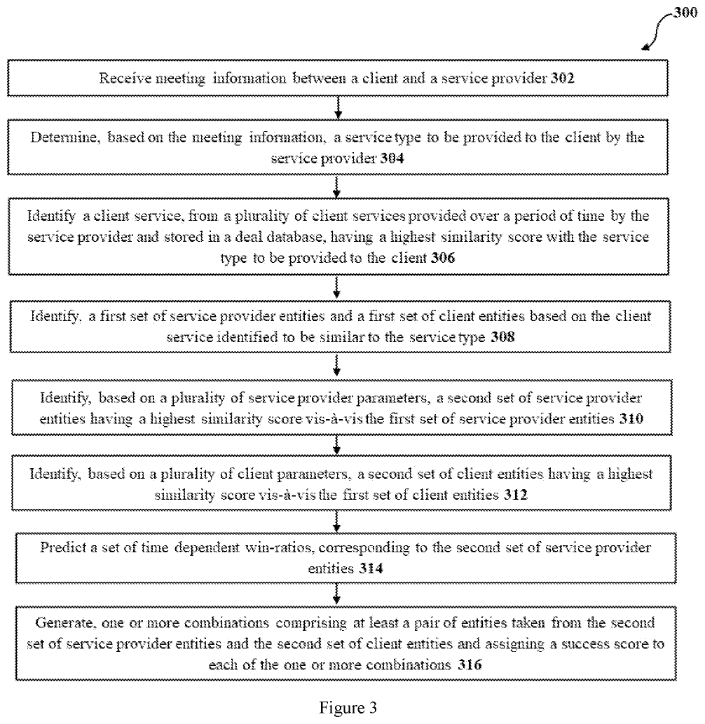

FIG. 3 depicts a method 300 for identifying at least a pair of entities for a meeting, in accordance with an embodiment of the present disclosure.

As illustrated in FIG. 3, the method 300 includes one or more blocks illustrating a method for identifying at least a pair of entities for a meeting. The method 300 may be described in the general context of computer executable instructions. Generally, computer executable instructions can include routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described.

At block 302, the method 300 may include receiving a meeting information between a client and a service provider.

At block 304, the method 300 may include determining, based on the meeting information, a service type to be provided to the client by the service provider.

At block 306, the method 300 may include identifying a client service, from a plurality of client services provided over a period of time by the service provider and stored in a deal database, having a highest similarity score with the service type to be provided to the client.

At block 308, the method 300 may include identifying, from the deal database, a first set of service provider entities and a first set of client entities based on the client service identified to be similar to the service type. The first set of service provider entities and the first set of client entities were involved in executing the client service between the service provider and the client respectively.

At blocks 310 and 312, the method 300 may include identifying a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively.

At block 314, the method 300 may include predicting a set of time dependent win-ratios, corresponding to the second set of service provider entities in such a manner that each time dependent win-ratio indicates a capability of a service provider entity of the second set of service provider entities to successfully execute the meeting with the client.

At block 316, the method 300 may include generating, based on the set of time dependent win-ratios, one or more combinations comprising at least a pair of entities taken from the second set of service provider entities and the second set of client entities, and assigning a success score to each of the one or more combinations predicting a probability for successfully attending the meeting.

### Computer System

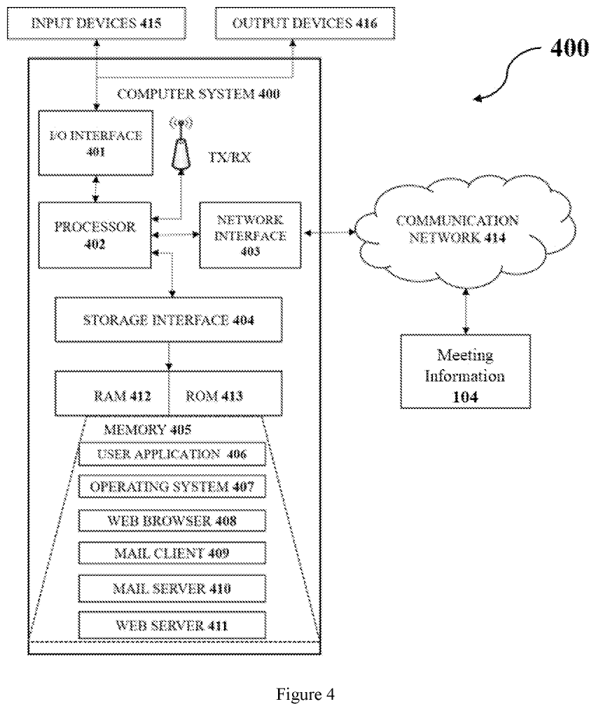

FIG. 4 illustrates a block diagram of an exemplary computer system 400 for implementing embodiments consistent with the present disclosure. It may be understood to a person skilled in art that the computer system 400 and its components is similar to the system 202 referred in FIG. 2. In an embodiment, the computer system 400 may be a peripheral device, which is used for facilitating systematic escalation of information related to an event in an organizational hierarchy. The computer system 400 may include a central processing unit (“CPU” or “processor”) 402. The processor 402 may comprise at least one data processor for executing program components for executing user or system-generated business processes. The processor 402 may include specialized processing units such as integrated system (bus) controllers, memory management control units, floating point units, graphics processing units, digital signal processing units, etc.

The processor 402 may be disposed in communication with one or more input/output (I/O) devices via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n /b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface, the computer system 400 may communicate with one or more I/O devices.

In some embodiments, the processor 402 may be disposed in communication with a communication network 414 via a network interface 403. The network interface 403 may communicate with the communication network 414. The communication unit may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc.

The communication network 414 can be implemented as one of the several types of networks, such as intranet or Local Area Network (LAN) and such within the organization. The communication network 414 may either be a dedicated network or a shared network, which represents an association of several types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 414 may include a variety of network devices, including routers, bridges, servers, computing devices, storage devices, etc.

In some embodiments, the processor 402 may be disposed in communication with a memory 405 (e.g., RAM 412, ROM 413, etc. as shown in FIG. 4) via a storage interface 404. The storage interface 404 may connect to the memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application, an operating system, a web browser, mail client, mail server, web server and the like. In some embodiments, computer system may store user/application data, such as the data, variables, records, etc. as described in this invention. Such databases may be implemented as fault-tolerant, relational, scalable, secure databases such as Oracle® or Sybase®.

The operating system may facilitate resource management and operation of the computer system. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLER ANDROID™, BLACKBERRY® OS, or the like. A user interface may facilitate display, execution, interaction, manipulation, or operation of program components through textual or graphical facilities. For example, user interfaces may provide computer interaction interface elements on a display system operatively connected to the computer system, such as cursors, icons, check boxes, menus, windows, widgets, etc. Graphical User Interfaces (GUIs) may be employed, including, without limitation, APPLE MACINTOSH® operating systems, IBM™ OS/2, MICROSOFT™ WINDOWS™ (XP™, VISTA™/7/8, 10 etc.), Unix® X-Windows, web interface libraries (e.g., AJAX™, DHTML™, ADOBE® FLASH™, JAVASCRIPT™, JAVA™, etc.), or the like.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

A description of an embodiment with several components in communication with each other does not imply that all such components are required. On the contrary, a variety of optional components are described to illustrate the wide variety of possible embodiments of the invention.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERENCE NUMERALS

| Reference Numeral | Description |
|---|---|
| 100 | Exemplary environment of a system for identifying |
| | at least a pair of entities for a meeting |
| 102 | Deal database |
| 104 | Meeting Information |
| 200 | Block diagram of the system |
| 202 | System |
| 204 | I/O Interface |
| 206 | Processor |
| 208 | Memory |
| 210 | Units |
| 212 | Receiving Unit |
| 214 | Determination Unit |
| 216 | Client Service Identification Unit |
| 218 | Entity Identification Unit |
| 220 | Prediction Unit |
| 222 | Generation Unit |
| 224 | Similarity Score Generation Unit |
| 226 | Network |
| 228 | User devices |
| 300 | Method for identifying at least a pair of entities |
| | for a meeting |

1. A method for identifying at least a pair of entities for a meeting, the method comprising:
receiving a meeting information between a client and a service provider;
determining, based on the meeting information, a service type to be provided to the client by the service provider;
identifying a client service, from a plurality of client services provided over a period of time by the service provider and stored in a deal database, having a highest similarity score with the service type to be provided to the client;
identifying, from the deal database, a first set of service provider entities and a first set of client entities based on the client service identified to be similar to the service type, wherein the first set of service provider entities and the first set of client entities were involved in executing the client service between the service provider and the client respectively;
identifying a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively;
predicting a set of time dependent win-ratios, corresponding to the second set of service provider entities in such a manner that each time dependent win-ratio indicates a capability of a service provider entity of the second set of service provider entities to successfully execute the meeting with the client;
generating, based on the set of time dependent win-ratios, one or more combinations comprising at least a pair of entities taken from the second set of service provider entities and the second set of client entities, wherein each combination is assigned with a success score predicting a probability for successfully attending the meeting, and wherein at least one combination is selected based on the success score.

2. The method as claimed in claim 1, further comprising generating a plurality of similarity scores corresponding to the plurality of client services against the service type by:
generating a plurality of client service vector representations corresponding to the plurality of client services stored in the deal database;
generating a service type vector representation corresponding to the service type to be provided to the client; and
applying a cosine similarity technique on each of the plurality of client service vector representations relative to the service type vector representation to calculate the plurality of similarity scores, for the plurality of client services, indicating a similarity level between each client service and the service type.

3. The method as claimed in claim 1, wherein:
the meeting information comprising at least one of client's name, client's business type, client's requirement, meeting location, and meeting time; and
the plurality of service provider parameters comprises at least one of designation, band-level, skills, experience, business unit and current availability of each of the first set of service provider entities, and wherein the plurality of client parameters comprises at least one of designation, band-level, skills, experience and business unit of each of the first set of client entities.

4. The method as claimed in claim 1, further comprising generating a plurality of similarity scores to identify the second set of service provider entities and the second set of client entities by:
generating a first set of service provider vector representations corresponding to the first set of service provider entities;
generating a first set of client vector representations corresponding to the first set of client entities;
generating a second set of service provider vector representations corresponding to a remaining set of service provider entities, wherein the remaining set of service provider entities are the entities associated with service provider excluding the first set of service provider entities;
generating a second set of client vector representations corresponding to a plurality of client entities; and
applying a cosine similarity technique on the second set of service provider vector representations and the second set of client vector representations vis-à-vis the first set of service provider vector representations and the first set of client vector representations respectively to calculate the plurality of similarity scores to identify the second set of service provider entities and the second set of client entities.

5. The method as claimed in claim 1, wherein the set of time dependent win-ratios, corresponding to the second set of service provider entities is predicted by using an Auto-Regressive Integrated Moving Average (ARIMA) model that allows forecasting a win-ratio for a service provider entity for a current time frame based on his/her performance in a previous time frame.

6. A system for identifying at least a pair of entities for a meeting, the system comprising:
a receiving unit configured to receive a meeting information between a client and a service provider;
a determination unit configured to determine, based on the meeting information, a service type to be provided to the client by the service provider;
a client service identification unit configured to identify a client service, from a plurality of client services provided over a period of time by the service provider and stored in a deal database, having a highest similarity score with the service type to be provided to the client;
an entity identification unit configured to:
identify, from the deal database, a first set of service provider entities and a first set of client entities based on the client service identified to be similar to the service type, wherein the first set of service provider entities and the first set of client entities were involved in executing the client service between the service provider and the client respectively; and
identify a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively;
a prediction unit configured to predict a set of time dependent win-ratios, corresponding to the second set of service provider entities in such a manner that each time dependent win-ratio indicates a capability of a service provider entity of the second set of service provider entities to successfully execute the meeting with the client; and
a generation unit configured to generate, based on the set of time dependent win-ratios, one or more combinations comprising at least a pair of entities taken from the second set of service provider entities and the second set of client entities, wherein each combination is assigned with a success score predicting a probability for successfully attending the meeting, and wherein at least one combination is selected based on the success score.

7. The system as claimed in claim 6, further comprises a similarity score generation unit configured to generate a plurality of similarity scores corresponding to the plurality of client services against the service type by:
generating a plurality of client service vector representations corresponding to the plurality of client services stored in the deal database; and
generating a service type vector representation corresponding to the service type to be provided to the client; and
applying a cosine similarity technique on each of the plurality of client service vector representations relative to the service type vector representation to calculate the plurality of similarity scores for the plurality of client services, indicating a similarity level between each client service and the service type.

8. The system as claimed in claim 6, wherein:
the meeting information comprising at least one of client's name, client's business type, client's requirement, meeting location, and meeting time; and
the plurality of service provider parameters comprises at least one of designation, band-level, skills, experience, business unit and current availability of each of the first set of service provider entities, and wherein the plurality of client parameters comprises at least one of designation, band-level, skills, experience and business unit of each of the first set of client entities.

9. The system as claimed in claim 6, wherein the similarity score generation unit is further configured to generate a plurality of similarity scores to identify the second set of service provider entities and the second set of client entities by:
generating a first set of service provider vector representations corresponding to the first set of service provider entities;
generating a first set of client vector representations corresponding to the first set of client entities;
generating a second set of service provider vector representations corresponding to a remaining set of service provider entities, wherein the remaining set of service provider entities are the entities associated with service provider excluding the first set of service provider entities;
generating a second set of client vector representations corresponding to a plurality of client entities; and
applying a cosine similarity technique on the second set of service provider vector representations and the second set of client vector representations vis-à-vis the first set of service provider vector representations and the first set of client vector representations respectively to calculate the plurality of similarity scores to identify the second set of service provider entities and the second set of client entities.

10. The system as claimed in claim 6, wherein the set of time dependent win-ratios, corresponding to the second set of service provider entities is predicted by using an Auto-Regressive Integrated Moving Average (ARIMA) model that allows forecasting a win-ratio for a service provider entity for a current time frame based on his/her performance in a previous time frame.

11. A non-transitory computer-readable storage medium including instructions stored thereon that when processed by a processor cause the system to perform operations comprising:
receiving a meeting information between a client and a service provider;
determining, based on the meeting information, a service type to be provided to the client by the service provider;
identifying a client service, from a plurality of client services provided over a period of time by the service provider and stored in a deal database, having a highest similarity score with the service type to be provided to the client;
identifying, from the deal database, a first set of service provider entities and a first set of client entities based on the client service identified to be similar to the service type, wherein the first set of service provider entities and the first set of client entities were involved in executing the client service between the service provider and the client respectively;
identifying a second set of service provider entities and a second set of client entities based on a plurality of service provider parameters and a plurality of client parameters respectively such that the second set of service provider entities and the second set of client entities have a highest similarity score vis-à-vis the first set of service provider entities and the first set of client entities respectively;
predicting a set of time dependent win-ratios, corresponding to the second set of service provider entities in such a manner that each time dependent win-ratio indicates a capability of a service provider entity of the second set of service provider entities to successfully execute the meeting with the client;
generating, based on the set of time dependent win-ratios, one or more combinations comprising at least a pair of entities taken from the second set of service provider entities and the second set of client entities, wherein each combination is assigned with a success score predicting a probability for successfully attending the meeting, and wherein at least one combination is selected based on the success score.

12. The medium as claimed in claim 11, further comprising instructions to generate a plurality of similarity scores corresponding to the plurality of client services against the service type by:
generating a plurality of client service vector representations corresponding to the plurality of client services stored in the deal database;
generating a service type vector representation corresponding to the service type to be provided to the client; and
applying a cosine similarity technique on each of the plurality of client service vector representations relative to the service type vector representation to calculate the plurality of similarity scores, for the plurality of client services, indicating a similarity level between each client service and the service type.

13. The medium as claimed in claim 11, wherein:
the meeting information comprising at least one of client's name, client's business type, client's requirement, meeting location, and meeting time; and
the plurality of service provider parameters comprises at least one of designation, band-level, skills, experience, business unit and current availability of each of the first set of service provider entities, and wherein the plurality of client parameters comprises at least one of designation, band-level, skills, experience and business unit of each of the first set of client entities.

14. The medium as claimed in claim 11, further comprising instructions to generate a plurality of similarity scores to identify the second set of service provider entities and the second set of client entities by:
generating a first set of service provider vector representations corresponding to the first set of service provider entities;
generating a first set of client vector representations corresponding to the first set of client entities;
generating a second set of service provider vector representations corresponding to a remaining set of service provider entities, wherein the remaining set of service provider entities are the entities associated with service provider excluding the first set of service provider entities;
generating a second set of client vector representations corresponding to a plurality of client entities; and
applying a cosine similarity technique on the second set of service provider vector representations and the second set of client vector representations vis-à-vis the first set of service provider vector representations and the first set of client vector representations respectively to calculate the plurality of similarity scores to identify the second set of service provider entities and the second set of client entities.

15. The medium as claimed in claim 11, wherein the set of time dependent win-ratios, corresponding to the second set of service provider entities is predicted by using an Auto-Regressive Integrated Moving Average (ARIMA) model that allows forecasting a win-ratio for a service provider entity for a current time frame based on his/her performance in a previous time frame.
